(19) United States
(12) Patent Application Publication
(10) Pub. No.: US 2024/0375758 A1
(43) Pub. Date: Nov. 14, 2024

(54) WATERCRAFT

(71) Applicant: MBC – Maritime Business & Consulting UG (Hanftungsbeschränkt) & Co., KG, Haren (DE)

(72) Inventors: Jürgen GERDES, Haren (DE); Oliver SCHEPERS, Haren (DE); Gerd STEFFENS, Haren (DE)

(73) Assignee: MBC – Maritime Business & Consulting UG (Hanftungsbeschränkt) & Co., KG, Haren (DE)

(21) Appl. No.: 18/554,425

(22) PCT Filed: Apr. 7, 2022
(86) PCT No.: PCT/DE2022/100261

§ 371 Date: Oct. 6, 2023

(30) Foreign Application Priority Data
Apr. 8, 2021 (DE) 102021108758.9

(51) Int. Cl. B63H 21/14; B63H 21/00; B63H 21/17; B63H 21/20; H01M 8/04082; H01M 8/0668; H01M 8/12; H01M 8/1233; H01M 10/42; H01M 16/00

(52) U.S. Cl. CPC B63H 21/14; B63H 21/17; B63H 21/20; H01M 8/04201; H01M 8/0668; H01M 8/1233; H01M 10/425; H01M 16/006; B63H 2021/003; B63H 2021/202; H01M 2008/1293; H01M 2010/4271; H01M 2220/20; H01M 2250/20

(57) ABSTRACT

An electric propulsion system for a watercraft having at least one engine 4 with at least one propulsion device 3 and a power plant 1, whereby the power plant 1 has at least one solid oxide fuel cell 2 for the oxidation of fuel.

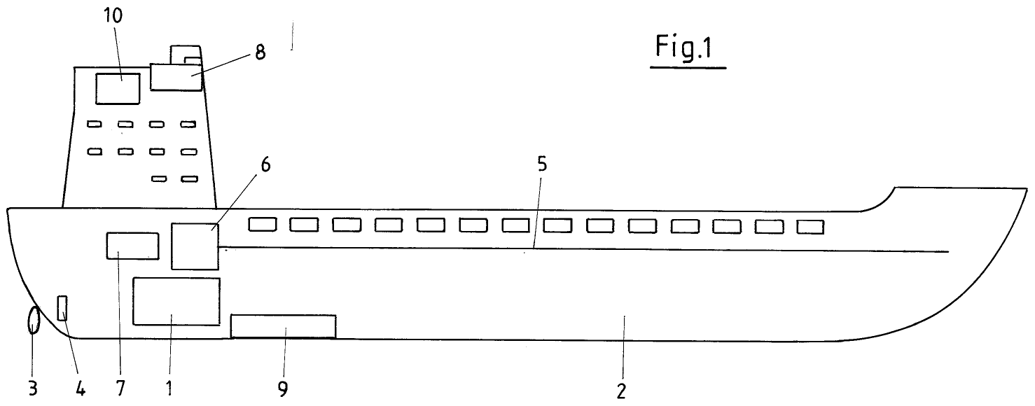

The invention relates to an electric propulsion system for watercraft having at least one electric motor, a propulsion device and a power plant.

The more than 140,000 ships that sail the world's oceans usually have a diesel engine that transmits the torque either directly or via a gearbox to the propeller shaft, which then drives a propeller. Since electricity is also needed on a ship, so-called auxiliary diesels are also in use, which generate diesel-electric electricity. The engines run permanently, with more power depending on the power requirement. The internal combustion engines of watercraft known to date convert fossil fuels into rotational energy, producing a significant amount of exhaust gases in the process. The fuel used in modern shipping is mainly heavy fuel oil or marine diesel oil, which is burned by diesel engines. As a result, a considerable amount of CO₂ escapes from the ship's funnels, but also NO_{X}, SO_{X}, particles, ash, etc. Global merchant shipping is responsible for transporting approximately 90% of the world's trade and produces approximately 2.9% of global CO₂ emissions. In order to be able to meet European and international climate targets, this high proportion must be significantly reduced. The pressure on shipping to implement the goal of zero emissions as soon as possible is enormous. There are other disadvantages surrounding the use of internal combustion engines on ships. These include, for example, noise emissions caused by ships and maritime objects stationed at sea, with their adverse effects on the environment. On the one hand, this applies to the people who live and work there, and on the other hand, to the marine environment. In particular, animals that rely on their acoustic sense for orientation, foraging, communication or predator avoidance can be permanently impaired. Noise caused by shipping is also the subject of binding resolutions of the International Maritime Organisation. It includes noise limits for the different premises within a ship. In addition to diesel engines, noise sources are mainly propeller shaft dynamics, pressure and bearing forces emanating from the propeller, air conditioning systems, manoeuvring equipment, especially transverse thrusters, winches, vortex separations, air inlets and outlets or shaft shocks.

Currently, there are various initiatives to reduce emissions in shipping with the help of renewable or synthetic energy sources. However, diesel engines are still used as the main drive and power generators. There are already projects in the shipping industry to specifically reduce CO₂ emissions. However, solutions devised so far are not really practicable because, for example, fuel tanks then become too complex and too large.

Thus, the present invention has the task of creating at least a largely emission-free propulsion system for watercraft.

This task is solved by the fact that the power plant includes at least one high-temperature fuel cell designed as a solid oxide fuel cell for the oxidation of a fossil or synthetic fuel.

According to the invention, internal combustion engines can be done without in the future on a relevant watercraft. Instead, a power plant consisting of at least one high-temperature fuel cell on board to oxidize a fossil or synthetic fuel replaces this technology. The aim is to make relevant watercraft completely emission-free. For this purpose, the diesel or combustion engine is completely replaced. Instead, the high-temperature fuel cell is used as a power plant and the best power plant on the ship is matched with the most suitable fuel in the ship. The power plant oxidizes the fuel in the fuel cell. Thanks to the combination of this new use functioning on the basis of high-temperature fuel cells, an emission-free or at least extremely low-emission ship can be realized.

High-temperature fuel cells designed as solid oxide fuel cells (SFOC or SOFC), which are used as a power plant and not only generate the rotational energy for the propeller(s), but also supply the electrical current for the ship, prove to be particularly suitable. Instead of a diesel engine, an electric motor drives the propulsion device, e.g., a propeller shaft, which draws its energy from the SFOC fuel cell instead of from a diesel generator, as was previously the case.

A preferred embodiment of the invention is that the power plant generates electrical and/or thermal power. Thus, the SFOC power plant uses the energy content of a fossil or synthetic fuel to generate electrical and thermal power. The only exhaust gas produced is water vapor and carbon dioxide. At the same time, the power plant is low-noise and largely eliminates the diesel engine as a source of noise.

Of particular importance in the present case is the fuel, which should originate from the group of alkanes and with which the electric drive according to the invention is accomplished and replaces heavy fuel oil or diesel oil. It is useful if methanol or ammonia is used as fuel. The specification is not just any fuel cell that runs on hydrogen, but a fuel cell that can be operated with methanol or other alkanes and that was found with the SFOC fuel cell. For the first time, a methanol fired SFOC is used on a ship. The combination is possible on any ship, not just an LNG ship.

The fact that the propulsion system is assigned a storage device used to receive the exhaust gas generated in the power plant is also advantageous in several respects. This is the case, for example, with a CO₂ capture and storage device, which captures the CO₂ exhaust gas generated in the SFOC power plant and stores it on board. The CO₂ is captured and stored in an MOF structure instead of separating it.

It is intrinsic to fuel cells that they can prove problematic in the face of rapid and violent load changes. Especially in shipping, however, such load changes caused by wind and swell naturally occur regularly. It is therefore appropriate for the propulsion system to be equipped with a storage device used to receive the energy generated in the power plant in order to compensate for the fluctuations in the ship's performance. For this purpose, a battery is integrated into the on-board electrical system as an energy store.

The battery storage system can release or absorb several times the stored energy in fractions of a second and thus stores the energy of the load fluctuations. In concrete terms, this is designed in such a way that a battery integrated into the on-board electrical system serves as a storage device, as has already been mentioned in principle.

This results in the SFOC fuel cell delivering the base load and the battery taking over power peaks. In case of negative peaks, the batteries can be charged accordingly. A special power management system is used for control, which automatically regulates the power distribution and ensures that the SFOC fuel cell is operated optimally.

In addition, the battery energy storage system serves as an emergency power supply if, for example, the SFOC power plant is temporarily or permanently unable to supply energy for technical reasons.

An advantageous embodiment of the invention provides that the electric motor obtains its drive energy from the SFOC power plant and/or the storage device, whereby the battery energy storage system compensates for possible load fluctuations in the network.

The watercraft according to the invention also opens up completely new possibilities in that the CO₂ produced by the gas valorization in the SFOC power plant is separated in a suitable capture device before it enters the atmospheric environment. According to one variant, the CO₂ can be stored on board for a longer period of time in order to release or sell it ashore in suitable ports. In this respect, it is necessary that at least one tank is provided on board the ship for the storage of the CO₂ recovered by gas valorisation. This means that one or more tanks are integrated into the ship in which the CO₂ can be stored. It is also envisaged that at least one tank will be provided on board the ship to store the fuel required for the power plant and at least one tank to store the CO₂ recovered from gas valorisation.

The fact that the recovered CO₂ can be used as an inert gas to reduce the risk associated with alcohol proves to be another advantageous design. Inert gas must be used in certain applications because of the substantial risk of explosion associated with alcohols. The captured CO₂ then takes over this function, supported by appropriate structural measures.

The aggregate state of the CO₂ must be taken into account. It is envisaged that an MOF storage tank, a cooled container and/or a pressure tank container will be used for the temporary storage of the CO₂. When storing the CO₂ in a gaseous state, the MOF storage tank is recommended, dry ice in the solid state and a pressure tank container under pressure between 5 bar and 70 bar in the liquid state. The storage unit is used to store unpressurized, pressurized and/or cooled CO₂ or the storage unit is used to store unpressurized, pressurized and/or cooled CO₂.

A further advantageous embodiment of the invention provides that the electrical energy in a central main switchboard is distributed to the electrical users and that the electric motor is supplied with energy from the central main switchboard.

In connection with the propulsion device, it is further proposed that a propeller, azipod, jet, etc. serves to drive the ship. The electric motor has the function of supplying the propulsion technology with energy. It is advisable to use an electric motor that can be reversed in the direction of rotation. An essential component of this is the on-board electrical system, i.e., the watercraft has an on-board network for the distribution of electrical energy, whereby the on-board electrical system is designed in alternating current (AC), direct current (DC) or a combination of both.

Another central unit of the electric drive according to the invention is the power management. The watercraft has a power management system that controls the power available in the main switchboard.

The power management system also has the function of automating the power consumption from the power plant and energy storage or optimizing the power consumption from the power plant and energy storage.

The fact that the power management system controls the charging/discharging of the energy storage system contributes significantly to the high efficiency of this system, whereby the power management system also includes a large number of safety functions and strategically controls energy efficiency.

The invention is characterized in particular by the fact that an electric propulsion system is created for a watercraft with at least one engine with at least one propulsion unit such as one or more propellers, azipod, water jet and a power plant in which the hitherto common and, in many respects problematic, fuel heavy oil/diesel and an engine driven by it are done without and replaced by an electric drive. For this purpose, a power plant with at least one solid oxide fuel cell is used to oxidize the fuel, which is conveniently methanol. The use of other fuels is also conceivable. At the same time, the power plant oxidizes the fuel in the fuel cell in a particularly environmentally friendly way. The object of the invention is thus an emission-free ship that converts a liquid fuel on board in a power plant into (electrical) energy and as a result does not produce any greenhouse gases, noise or other emissions. The watercraft according to the invention comprises an electric propulsion system consisting of a rotating propeller, a nacelle-like propulsion module (azimuth), a water jet propulsion system or any other electric propulsion system. The watercraft according to the invention also comprises an electric motor (propulsion motor), the direction of rotation of which can be changed and, above all, an SFOC power plant (high-temperature solid oxide fuel cell), which oxidizes fossil or synthetic fuel such as methanol, ammonia, alcohols, etc. in a fuel cell, reforms it into synthesis gas and generates the required electrical energy. For the storage of the fuel, the ship according to the invention comprises a suitable fuel tank or a CO₂ capture and storage system, which captures the CO₂ exhaust gases generated in the SFOC power plant and stores them on board. The collected CO₂ can be stored without pressure, cooled or under pressure, with the possibility of releasing and selling the collected CO₂ at suitable points on land. In addition, a battery energy storage system is planned, which both covers power fluctuations of the ship and optimizes electrical energy consumption, and also serves as an emergency power generator. Furthermore, an on-board electrical system for alternating current (AC), direct current (DC) or a combination of on-board electrical systems has been implemented, including suitable main switchgear and with an intelligent and suitable power management system, which controls the complex power requirements for the propulsion system and optimizes electrical on-board consumption in order to ultimately be able to operate the maritime watercraft emission-free and energy-efficiently.

In order to absorb power fluctuations, the battery energy storage system is integrated into the on-board electrical system. The battery storage system can release or absorb several times the stored energy in fractions of a second and thus supplies and stores the energy of the load fluctuations. In addition, the battery energy storage system serves as an emergency power supply if, for example, the SFOC power plant is unable to supply energy for technical reasons. In order to optimize the energy production of the SFOC power plant as well as the energy extraction for propulsion, the maritime object will be equipped with a special, intelligent power management system automation, which ensures that the SFOC power plant is always operated in the optimal operating window, but also that the required propulsion and electrical energy is always safely available for the maritime object.

Further details and advantages of the subject-matter of the invention can be found in the following description of the associated drawing, in which a preferred embodiment is shown with the necessary details and individual parts, specifically a diagram of the function of the electric drive.

In this illustration, the propulsion system of the watercraft, which is designed as ship 2, is generally designated as 3 and includes an electric motor 4, which is integrated into the power network 5 in such a way that it draws its energy either from the SFOC power plant 1 or the battery energy storage 6. This storage system compensates for possible load fluctuations in the network 5. All electrical users are connected to the power grid 5 and are controlled in a suitable main switchboard 7. An intelligent power management system controls and optimizes the energy supply of the electrical users. The tank for storing methanol or other fuel is shown with 9 and 10 is the storage tank for temporary storage of CO₂.

1. Electric drive for a watercraft, with at least one electric motor (4), a pro-pulsion device (3) and a power plant (1), wherein
the power plant (1) includes at least one high-temperature fuel cell (2) designed as a solid oxide fuel cell (2) for the oxidation of a fossil or synthetic fuel.

2. Electric drive according to claim 1, wherein
the power plant (1) produces electrical and/or thermal power.

3. Electric drive according to claim 1, wherein
the fuel comes from the group of alkanes.

4. Electric drive according to claim 1, wherein
the drive is assigned a storage device (6) used to receive the energy generated in the power plant (1).

5. Electric drive according to claim 4, wherein
the storage device (6) is intended to compensate for fluctuations in the power of the watercraft.

6. Electric drive according to claim 5, wherein
a battery integrated into the on-board electrical system (5) serves as a storage device (6).

7. Electric drive according to claim 5, wherein
the storage device (6) is designed as an emergency power supply.

8. Electric drive according to claim 1, wherein
the engine (4) obtains its energy from the SFOC power plant (1) and/or the stor-age device (6).

9. Electric drive according to claim 1, wherein
at least one tank (9) is provided on board the ship (2) for the storage of the fuel required for the power plant (1).

10. Electric drive according to claim 1, wherein
at least one container (10) is provided on board the ship (2) for the storage of CO2 recovered by gas valorization.

11. Electric drive according to claim 1, wherein
the recovered CO2 serves as an inert gas to reduce the risk associated with the alcohol.

12. Electric drive according to claim 10, wherein
a MOF storage tank, a cooled container and/or a pressure tank container are used for the temporary storage of the CO2.

13. Electric drive according to claim 11, wherein
the tank (10) is used to store unpressurized, pressurized and/or cooled CO2.

14. Electric drive according to claim 1, wherein
the electrical energy is distributed to the electricity consumers in a central main switchboard (7).

15. Electric drive according to claim 14, wherein
the central main switchboard (7) is used to supply energy to the electric motor (4).

16. Electric drive according to claim 1, wherein
a propeller, azipod, jet, etc., serves for propulsion (3) of the ship (2).

17. Electric drive according to claim 1, wherein
the ship has an on-board electrical system (5) for the distribution of electrical en-ergy.

18. Electric drive according to claim 1, wherein
the watercraft has a power management system (8) that controls the power avail-able in the main switchboard (7).

19. Electric drive according to claim 18, wherein
the power management system (8) automates the power consumption from the power plant (1) and the energy storage (6).

20. Electric drive according to claim 18, wherein
the power management system (8) controls the charging/discharging of the energy storage device (6).
